(19) United States
(12) Patent Application Publication
(10) Pub. No.: US 2024/0304867 A1
(43) Pub. Date: Sep. 12, 2024

(54) EFFICIENT AND ENERGY-SAVING SYSTEM FOR BATTERY FORMATION AND GRADING

(71) Applicant: Jiangsu KATOP Automation Co., Ltd., Changzhou City (CN)

(72) Inventors: Leifeng Wang, Changzhou City (CN); Anmin Zhang, Changzhou City (CN); Yunqing Wu, Changzhou City (CN)

(21) Appl. No.: 18/669,632

(22) Filed: May 21, 2024

(30) Foreign Application Priority Data
Sep. 12, 2023 (CN) 2023224790035

(51) Int. Cl. H01M 10/058; H01M 10/44; H02J 7/00

(52) U.S. Cl. CPC H01M 10/058; H01M 10/446; H02J 7/0045; H02J 7/0069; H01M 10/441; H02J 7/0013

(57) ABSTRACT

Provided herein is an efficient and energy-saving system for battery formation and grading, which includes a busbar, a charging module, a discharging module, a load transfer unit, a limiting unit and a formation fixture. The busbar is connected to an external constant current source. The formation fixture is used for loading a plurality of lithium batteries to be formation and grading. The load transfer unit is used for moving a lithium battery. The limiting unit is used for intercepting and positioning the lithium battery when it reaches a designated station, and releasing the lithium battery when it is about to move to the next station. Advantageously, the charging module and the discharging module are arranged independently, so that all the charging module and the discharging module can work simultaneously without forming any idle charging circuit or discharging circuit, thereby reducing the energy loss and system cost due to idle circuit.

### CROSS-REFERENCE TO RELATED APPLICATIONS

This application claims priority to Chinese Patent Application No. 2023224790035, filed on Sep. 12, 2023, which is hereby incorporated by reference herein in its entirety.

### TECHNICAL FIELD

The disclosure relates to the field of devices for battery formation and grading, in particular to an efficient and energy-saving system for battery formation and grading.

### BACKGROUND ART

In the existing system for battery formation and grading, a charging circuit and a discharging circuit are provided in a same module. Both charging and discharging can be performed at each station, with a lithium battery undergoing both processes at the same station. This arrangement results in either the charging circuit or the discharging circuit being idle, forming an idle circuit within a formation device, which leads to an extra energy consumption and a low utilization rate of electrical energy.

### SUMMARY

The present application provides an efficient and energy-saving system for battery formation and grading.

The technical scheme adopted by the present application is as follows.

An efficient and energy-saving system for battery formation and grading comprises a busbar, a load transfer unit, a charging station and a discharging station;

the charging station is provided with a charging module for charging a lithium battery on a charging station, and the discharging station is provided with a discharging module for discharging the lithium battery on a discharging station, wherein the charging module and the discharging module are electrically connected to the busbar, and the busbar is connected to an external constant current source to provide power for the charging module and the discharging module; and

the load transfer unit is arranged below the charging module and the discharging module, and is used for moving the lithium battery from the charging station to the discharging station or from the discharging station to the charging station.

According to one or more embodiments, the charging station and the discharging station are alternately arranged.

According to one or more embodiments, the system further comprises a formation fixture for loading the lithium battery.

According to one or more embodiments, the system further comprises a limiting unit for intercepting, positioning or releasing the lithium battery.

According to one or more embodiments, the system further includes a charging connection means and a discharging connection means. The charging connection means is arranged above the charging station and is electrically connected to the charging module, and can connect the lithium battery on the charging station with the charging module to form a charging circuit. The discharging connection means is arranged above the discharging station and is electrically connected to the discharging module, and can connect the lithium battery on the discharging station with the discharging module to form a discharging circuit.

According to one or more embodiments, the charging connection means is provided with at least one first positive probe and at least one first negative probe, and the first positive probe can be electrically connected to a positive electrode of the lithium battery on the charging station, and the first negative probe can be electrically connected to a negative electrode of the lithium battery on the charging station.

According to one or more embodiments, the discharging connection means is provided with at least one second positive probe and at least one second negative probe, and the second positive probe can be electrically connected to the positive electrode of the lithium battery on the discharging station, and the second negative probe can be electrically connected to the negative electrode of the lithium battery on the discharging station.

According to one or more embodiments, the system further comprises a driving unit for driving the charging connection means and the discharging connection means to contact with the lithium battery to form an electrical circuit.

Compared with the prior art, the present application has at least the following beneficial effects:

the charging module and the discharging module are independently arranged, so that all the charging module and the discharging module can work simultaneously without forming any idle charging circuit or discharging circuit, thereby reducing the energy loss and system cost due to idle circuits.

### BRIEF DESCRIPTION OF THE DRAWINGS

The disclosure will be further explained with the attached drawings and embodiments.

FIG. 1 shows a first structural diagram of an efficient and energy-saving system for battery formation and grading according to an embodiment of the present application; and

FIG. 2 shows a second structural diagram of an efficient and energy-saving system for battery formation and grading according to an embodiment of the present application.

Where 1 is a busbar; 2 is a charging module; 3 is a discharging module; 4 is a lithium battery; 5 is a load transfer unit; 6 is a limiting unit; 7 is a formation fixture; and 8 is a charging connection means.

### DETAILED DESCRIPTION

The concept, concrete structure and technical effects of this disclosure will be described clearly and completely with embodiments and drawings, so as to fully illustrate the purpose, characteristics and effects of this disclosure. Obviously, the described embodiment is only a part of the embodiment of the disclosure. Based on the embodiment of the disclosure, other embodiments obtained by those skilled in the art without paying creative labors belong to the protection scope of the disclosure. In addition, all the connection/connection relationships involved in the disclosure do not mean that the single-finger components are directly connected, but that a better connection structure can be formed by adding or reducing connection accessories according to the specific implementation situation. All technical features in the creation of the disclosure can be combined interactively without conflicting with each other.

Before shipping, lithium batteries generally require several rounds of charging and discharging tests to activate the chemical substances within the battery, a process known as formation. Due to individual differences, even batteries from the same batch have different capacities. For operational use, it is often necessary to series and parallel combine batteries of the same capacity, requiring the detection and pairing of batteries with identical capacities, a process known as grading. Therefore, during the battery formation and grading stage, the system for battery formation and grading needs to repeatedly charge and discharge the batteries and calculate the capacity of each battery during this process. Consequently, the core components of the system for battery formation and grading consists of a charging part and a discharging part.

In existing systems for battery formation and grading, the charging and discharging circuits are typically arranged within a same module. Each workstation can be charged and discharged, and the charging and discharging of a lithium battery share one workstation. This arrangement results in either the charging circuit or the discharging circuit being idle, forming an idle circuit within a formation device, which leads to an extra energy consumption and a low utilization rate of electrical energy.

In order to solve the above problems, the present application puts forward an efficient and energy-saving system for battery formation and grading.

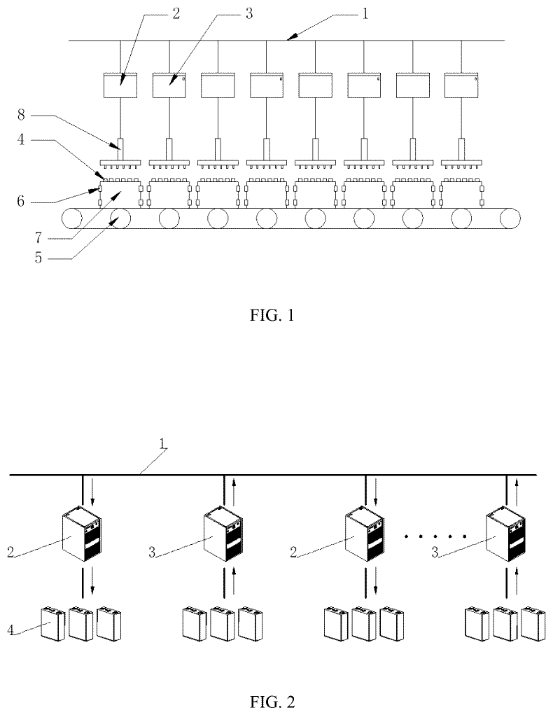

Referring to FIG. 1 and FIG. 2, an efficient and energy-saving system for battery formation and grading according to the present application comprises a busbar 1, a charging station and a discharging station. The charging station is provided with a charging module 2 for charging the lithium battery on the charging station, and the discharging station is provided with a discharging module 3 for discharging the lithium battery on the discharging station. Both the charging module 2 and the discharging module 3 are electrically connected to the busbar 1, which itself is connected to an external constant current source to provide power to the charging module 2 and the discharging module 3.

Specifically, the busbar 1 is connected to the external constant current source, and is electrically connected to the charging module 2 and the discharging module 3, so as to provide power for the charging module 2 and the discharging module 3. The charging module 2 is arranged on the charging station for charging the lithium battery 4 on the charging station. The discharging module 3 is arranged on the discharging station for discharging the lithium battery on the discharging station. The charging module 2 and the discharging module 3 are independently arranged, so that both the charging module 2 and the discharging module 3 can work simultaneously, which avoids the extra energy consumption caused by an idle circuit, and improves the utilization rate of electric energy and the efficiency of the battery formation and grading.

In this embodiment, the charging station and the discharging station are alternately arranged, so that after the lithium battery is charged or discharged, it only needs to be moved to next workstation to complete an entire charging and discharging cycle, thereby improving the efficiency of a formation and grading cycle.

According to one or more embodiments, the efficient and energy-saving system for battery formation and grading comprises a load transfer unit 5, which is arranged below the charging module 2 and the discharging module 3. The load transfer unit 5 moves a lithium battery from the charging station to the discharging station after charging is complete, or from the discharging station to the charging station after discharging is complete, thus facilitating the completion of the charge-discharge cycle. According to some examples, the load transfer unit 5 is a conveyor belt. Without limitation, it can be understood that the load transfer unit 5 can also be a manipulator or an automatic guiding device.

According to one or more embodiments, the efficient and energy-saving system for battery formation and grading comprises a formation fixture 7 for loading lithium batteries. In order to improve the efficiency of the formation and grading process, the formation fixture 7 is configured to hold and secure a plurality of lithium batteries to be formation and grading. And the formation fixture 7 loaded with a plurality of lithium batteries is placed in a charging station or a discharging station, so that the charging module 2 or the discharging module 3 at a single station can charge or discharge a plurality of lithium batteries, which greatly improves the efficiency of the formation and grading process. In some examples, three lithium batteries are loaded in one formation fixture 7. Without limitation, it can be understood that the number of lithium batteries loaded in the formation fixture 7 can be adjusted according to the actual situation.

According to one or more embodiments, the efficient and energy-saving system for battery formation and grading comprises a limiting unit 6, which is arranged at one side of the load transfer unit 5 and is used for intercepting, positioning or releasing the lithium battery. When the load transfer unit 5 moves the lithium battery to a designated station, the limiting unit 6 intercepts and positions the lithium battery, so that the lithium battery can be stabilized at the designated station. When the lithium battery completes the charging or discharging task at this station, the limiting unit 6 releases it, and the load transfer unit 5 moves the lithium battery to the next station.

In an embodiment, the limiting unit 6 is arranged at one side of the load transfer unit 5, and the limiting unit 6 is a barrier gripper. When the lithium battery is moved to the designated station by the load transfer unit 5, the limiting unit 6 horizontally extends above the load transfer unit 5 under the drive of the motor or cylinder, so as to intercept, position and firmly fix the lithium battery, and stabilize the lithium battery at the designated station. Once the lithium battery has completed its charging or discharging task at that station, the limiting unit 6 releases the battery and retracts to leave from above the load transfer unit 5 under the power of the motor or cylinder, so that the battery can be moved to the next station by the load transfer unit 5. Without limitation, it can be understood that the limiting unit 6 can also be arranged under the load transfer unit 5, and the limiting unit 6 can also be a baffle or other structure. In another embodiment, the limiting unit 6 is arranged under the load transfer unit 5, and the limiting unit 6 is provided as a baffle structure. When the lithium battery is moved to the designated station by the load transfer unit 5, the limiting unit 6 is driven by the motor or cylinder to rise vertically, and its highest point is higher than the horizontal plane of the load transfer unit 5, so as to intercept and position the lithium battery and stabilize the lithium battery at the designated station. When the lithium battery is charged or discharged at this station, the limiting unit 6 vertically descends under the drive of the motor or cylinder, and its highest point is lower than the horizontal plane of the load transfer unit 5, so that the limiting unit 6 will not block the movement of the lithium battery, and the load transfer unit 5 moves the lithium battery to the next station.

According to one or more embodiments, the efficient and energy-saving system for battery formation and grading comprises a charging connection means 8 and a discharging connection means, wherein the charging connection means 8 is arranged above the charging station and is electrically connected to the charging module 2, and wherein the charging connection means 8 is used for connecting the lithium battery on the charging station with the charging module 2 to form a charging circuit. The discharging connection means is arranged above the discharging station and is electrically connected to the discharging module 3. The discharging connection means is used to connect the lithium battery on the discharging station with the discharging module 3 to form a discharging circuit. In addition, the efficient and energy-saving system for battery formation and grading further comprises a driving unit, and the driving unit is used for driving the charging connection means and the discharging connection means to contact with the lithium battery to form an electrical circuit.

Specifically, the charging connection means 8 is arranged below the charging module 2 and above the charging station. The charging connection means 8 is electrically connected to the charging module 2, and can be electrically connected to the lithium battery on the charging station, so that the lithium battery and the charging module 2 form a charging circuit. The discharging connection means is arranged below the discharging module 3 and above the discharging station. The discharging connection means is electrically connected to the discharging module 3, and can be electrically connected to the lithium battery on the discharging station, so that the lithium battery and the discharging module 3 form a discharging circuit.

The charging connection means 8 is provided with at least one first positive probe and at least one first negative probe. When the charging module 2 charges the lithium battery on the charging station, the first positive probe is electrically connected to a positive electrode of the lithium battery on the charging station, and the first negative probe is electrically connected to a negative electrode of the lithium battery on the charging station. In an embodiment, the charging connection means 8 is provided with three first positive probes and three first negative probes, so that three lithium batteries can be simultaneously connected to the charging module 2. Without limitation, it can be understood that the number of the first positive probe and the first negative probe can be adjusted according to the number of lithium batteries loaded on the formation fixture 7 and the actual situation.

Similarly, the discharging connection means is provided with at least one second positive probe and at least one second negative probe. When the discharging module 3 charges the lithium battery on the discharging station, the second positive probe is electrically connected to the positive electrode of the lithium battery on the discharging station, and the second negative probe is electrically connected to the negative electrode of the lithium battery on the discharging station. In an embodiment, the discharging connection means is provided with three second positive probes and three second negative probes, so that three lithium batteries can be simultaneously connected to the discharging module 3. Without limitation, it can be understood that the number of the second positive probe and the second negative probe can be set according to the number of lithium batteries loaded on the formation fixture 7 and the actual situation.

The driving unit is used to drive the charging connection means and the discharging connection means to contact with the lithium battery to form an electrical circuit. Specifically, when the lithium battery is moved to the charging station by the load transfer unit 5, the driving unit drives the charging connection means to descend until the first positive probe of the charging connection means contacts with the positive electrode of the lithium battery, and the first negative probe of the charging connection means contacts with the negative electrode of the lithium battery. And then the driving unit stops the descending of the charging connection means and stabilizes the position of the charging connection means. Once the lithium battery completes a charging task, the driving unit drives the charging connection means to rise, so that the first positive probe of the charging connection means leaves the positive electrode of the lithium battery and the first negative probe of the charging connection means leaves the negative electrode of the lithium battery.

Specifically, the working process of the efficient and energy-saving system for battery formation and grading according to the present application is as follows.

A plurality of formation fixture 7 loaded with one or more batteries to be formation and grading are placed on the load transfer unit 5; the load transfer unit 5 carries the formation fixture 7 loaded with the lithium batteries to be formation and grading and moves it to a designated station, and the limiting unit 6 intercepts and positions the formation fixture 7 loaded with the lithium batteries to be formation and grading. The driving unit then drives the charging connection means connected to the charging module 2 and the discharging connection means connected to the discharging module 3 to descend, so that the positive probe on the connection means is connected to the positive electrode of the lithium battery, and the negative probe on the connection means is connected to the negative electrode of the lithium battery, which enables a circuit to be formed between the charging module 2 or the discharging module 3 and the lithium battery for charging or discharging tasks. When the lithium battery is charged or discharged, the driving unit drives the charging connection means connected to the charging module 2 and the discharging connection means connected to the discharging module 3 to rise, so that the positive and negative probes of the connection means leave the positive and negative electrodes of the lithium battery. The limiting unit 6 retracts and thus releases the formation fixture 7, and the load transfer unit 5 then carries the formation fixture 7 loaded with the lithium batteries and moves it to the next station. Due to the independent arrangement of the charging module 2 and the discharging module 3, all the charging modules 2 and the discharging module 3 can work simultaneously, which greatly improves the efficiency of the lithium battery formation and grading process.

The above merely describes specific embodiments of the present disclosure, which is not intended to limit the scope of protection of the present disclosure. Any modifications, equivalent variations or substitutions, and improvements made within the spirit and principle of the present disclosure by those skilled in the art according to the disclosed technical scope should be included in the protection scope of the present disclosure.

1. A system for battery formation and grading, comprising a busbar, a load transfer unit, a charging station and a discharging station;
wherein the charging station is provided with a charging module for charging a lithium battery on the charging station, and the discharging station is provided with a discharging module for discharging the lithium battery on the discharging station, and wherein the charging module and the discharging module are electrically connected to the busbar, and the busbar is connected to an external constant current source to provide power for the charging module and the discharging module; and
wherein the load transfer unit is arranged below the charging module and the discharging module, and is used for moving the lithium battery from the charging station to the discharging station or from the discharging station to the charging station.

2. The system for battery formation and grading according to claim 1, wherein the charging station and the discharging station are alternately arranged.

3. The system for battery formation and grading according to claim 1, further comprising a formation fixture for loading the lithium battery.

4. The system for battery formation and grading according to claim 1, further comprising a limiting unit for intercepting, positioning or releasing the lithium battery.

5. The system for battery formation and grading according to claim 1, further comprising a charging connection means and a discharging connection means;
wherein the charging connection means is arranged above the charging station and is electrically connected to the charging module, and connects the lithium battery on the charging station with the charging module to form a charging circuit; and
wherein the discharging connection means is arranged above the discharging station and is electrically connected to the discharging module, and connects the lithium battery on the discharging station with the discharging module to form a discharging circuit.

6. The system for battery formation and grading according to claim 5, wherein the charging connection means is provided with at least one first positive probe and at least one first negative probe, and the first positive probe is electrically connected to a positive electrode of the lithium battery on the charging station, and the first negative probe is electrically connected to a negative electrode of the lithium battery on the charging station.

7. The system for battery formation and grading according to claim 5, wherein the discharging connection means is provided with at least one second positive probe and at least one second negative probe, and the second positive probe is electrically connected to a positive electrode of the lithium battery on the discharging station, and the second negative probe is electrically connected to a negative electrode of the lithium battery on the discharging station.

8. The system for battery formation and grading according to claim 5, further comprising a driving unit for driving the charging connection means and the discharging connection means to contact with the lithium battery to form an electrical circuit.
